(19) United States
(12) Patent Application Publication
(10) Pub. No.: US 2014/0071248 A1
(43) Pub. Date: Mar. 13, 2014

(54) DISPLAY CONTROL APPARATUS, IMAGE CAPTURE APPARATUS, CONTROL METHOD AND STORAGE MEDIUM

(71) Applicant: Canon Kabushiki Kaisha, Tokyo (JP)

(72) Inventor: Shinnosuke Torii, Kawasaki-shi (JP)

(73) Assignee: Canon Kabushiki Kaisha, Tokyo (JP)

(21) Appl. No.: 14/013,648

(22) Filed: Aug. 29, 2013

(30) Foreign Application Priority Data
Sep. 12, 2012 (JP) 2012-200878

(51) Int. Cl. H04N 13/02

(52) U.S. Cl. CPC H04N 13/021
USPC 348/49; 348/55

(57) ABSTRACT

When image processing for performing left-right inversion of images is applied to obtained left-eye and right-eye images for binocular stereopsis, a display control apparatus outputs the left-eye image with left and right inverted so that it is displayed on a display apparatus for the right eye. Likewise, the display control apparatus outputs the right-eye image with left and right inverted so that it is displayed on the display apparatus for the left eye. The display apparatus displays these left-eye and right-eye images in such a manner that they can be viewed in binocular stereopsis.

### BACKGROUND OF THE INVENTION

1. Field of the Invention

The present invention relates to a display control apparatus, an image capture apparatus, a control method and a storage medium, and particularly to a display technique used in a display apparatus that enables binocular stereopsis.

2. Description of the Related Art

Image capture apparatuses, such as digital cameras and digital video cameras, have a display device that functions as an electronic viewfinder by displaying through-the-lens images during image capture. Some of these image capture apparatuses are capable of making a display surface of the display apparatus face a subject through rotation. The display apparatus is rotated in order for a camera operator, for example, to check an image to be captured when he/she attempts to capture an image of him/herself. When an image to be captured is thus displayed to the subject, the display apparatus displays what is called a mirror image in which left and right are inverted compared to an image normally displayed, so that the subject can easily recognize a range of image capture (Japanese Patent No. 4065464).

Meanwhile, there are image capture apparatuses capable of capturing images that can be viewed in binocular stereopsis. Some of these image capture apparatuses have a display apparatus that displays through-the-lens images and captured images in such a manner that they can be viewed in binocular stereopsis (Japanese Patent Laid-Open No. 9-182113).

However, when an image capture apparatus with a display apparatus that enables binocular stereopsis displays left-eye and right-eye images with left and right inverted as described in Patent Document 1 while a display surface of the display apparatus is facing a subject, an observer who is the subject may not be able to perceive the correct stereoscopic effect.

### SUMMARY OF THE INVENTION

The present invention was made in view of such problems in the conventional technique. The present invention provides a display control apparatus, an image capture apparatus, a control method and a storage medium that allow an observer to perceive the correct stereoscopic effect when displaying images for binocular stereopsis with left and right inverted.

The present invention in its first aspect provides a display control apparatus comprising: an obtaining unit configured to obtain a left-eye image and a right-eye image for binocular stereopsis; an image processing unit configured to apply image processing for display to the left-eye image and the right-eye image obtained by the obtaining unit; and a display output unit configured to output the left-eye image and the right-eye image to which the image processing unit has applied the image processing for display to a display apparatus capable of display in binocular stereopsis, wherein the display output unit includes: a left-eye display output unit configured to output an image to be displayed on the display apparatus for a left eye; and a right-eye display output unit configured to output an image to be displayed on the display apparatus for a right eye, and in a case where the image processing unit applies image processing for performing left-right inversion of images, the display output unit causes the right-eye display output unit to output the left-eye image with left and right inverted, and causes the left-eye display output unit to output the right-eye image with left and right inverted.

The present invention in its second aspect provides an image capture apparatus comprising: an image capture unit configured to capture a left-eye image and a right-eye image for binocular stereopsis; a setting unit configured to set one of a plurality of modes of the image capture apparatus, the modes including at least an image capture mode for capturing an image of a subject using the image capture unit, and a playback mode for playing back an image stored in a storage unit; and the display control apparatus according to the first aspect, wherein the image processing unit of the display control apparatus applies the image processing for performing left-right inversion of images when the image capture mode is set by the setting unit.

The present invention in its third aspect provides a control method for a display control apparatus, the control method comprising: an obtaining step in which an obtaining unit of the display control apparatus obtains a left-eye image and a right-eye image for binocular stereopsis; an image processing step in which an image processing unit of the display control apparatus applies image processing for display to the left-eye image and the right-eye image obtained in the obtaining step; and a display output step in which a display output unit of the display control apparatus outputs the left-eye image and the right-eye image to which the image processing for display has been applied in the image processing step to a display apparatus that enables display in binocular stereopsis, wherein the display output unit includes: a left-eye display output unit configured to output an image to be displayed on the display apparatus for a left eye; and a right-eye display output unit configured to output an image to be displayed on the display apparatus for a right eye, and in a case where image processing for performing left-right inversion of images is applied in the image processing step, the display output unit causes the right-eye display output unit to output the left-eye image with left and right inverted and causes the left-eye display output unit to output the right-eye image with left and right inverted in the display output step.

Further features of the present invention will become apparent from the following description of exemplary embodiments (with reference to the attached drawings).

### BRIEF DESCRIPTION OF THE DRAWINGS

FIG. 1 is a block diagram showing a configuration of a digital camcorder 100 according to embodiments of the present invention.

FIGS. 2A and 2B illustrate a normal state of placement of a display unit 108 according to the embodiments of the present invention.

FIG. 3 illustrates a state where the front and back of the display unit 108 according to the embodiments of the present invention are inverted.

FIGS. 4A, 4B, 4C and 4D illustrate failure in binocular stereopsis according to the embodiments of the present invention.

FIG. 5 is a flowchart showing an example of display control processing executed by a digital camcorder 100 according to Embodiment 1 of the present invention.

### DESCRIPTION OF THE EMBODIMENTS

### Embodiment 1

The following is a detailed description of an illustrative embodiment of the present invention with reference to the drawings. It should be noted that embodiments described below provides an example in which the present invention is applied to a digital camcorder which is one example of a display control apparatus and is capable of capturing and displaying images for binocular stereopsis. However, the present invention is applicable to any apparatus that is capable of outputting left-eye and right-eye images for binocular stereopsis.

<<Configuration of Digital Camcorder 100>>

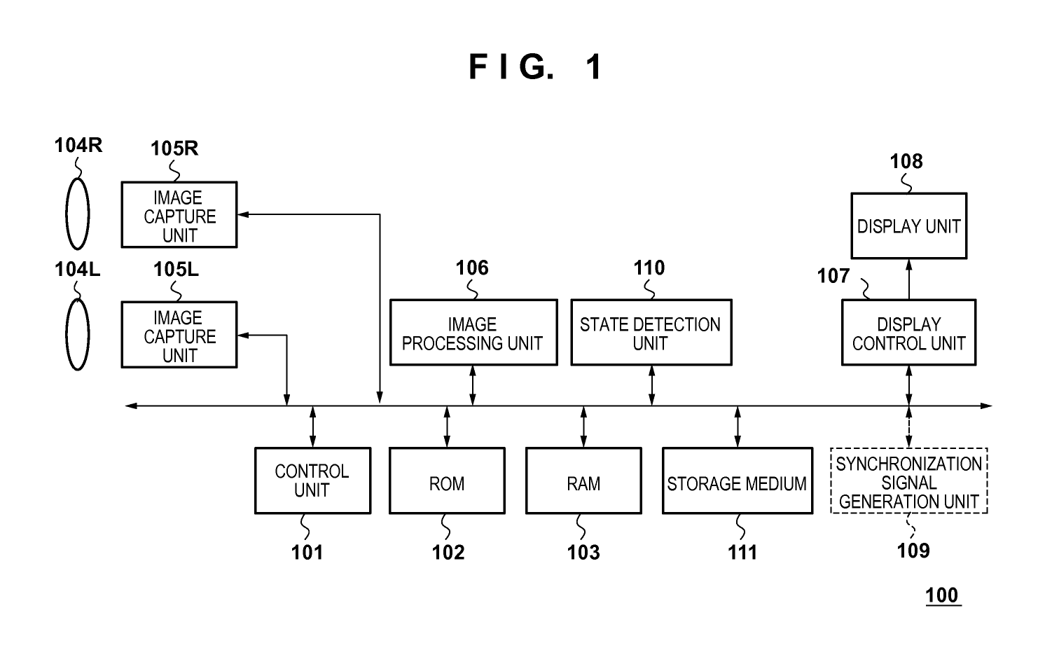

FIG. 1 is a block diagram showing a functional configuration of a digital camcorder 100 according to the embodiment of the present invention.

A control unit 101 is, for example, a CPU and controls the operations of blocks included in the digital camcorder 100. More specifically, the control unit 101 controls the operations of the blocks by reading operation programs for the blocks stored in a ROM 102, deploying the read operation programs to a RAM 103, and executing the deployed operation programs.

The ROM 102 is, for example, a rewritable nonvolatile memory. The ROM 102 stores not only the operation programs for the blocks included in the digital camcorder 100, but also parameters and the like necessary for the operations of the blocks. The RAM 103 is a volatile memory used as a working memory. The RAM 103 is used not only as an area to which the operation programs for the blocks are deployed, but also as a storage area for storing intermediate data and the like output through the operations of the blocks. The RAM 103 also stores information on a mode that is currently set in the digital camcorder 100. The digital camcorder 100 according to the present embodiment has at least an image capture mode for capturing images for binocular stereopsis and a playback mode for playing back images for binocular stereopsis via an operation input unit which is not shown in the figures.

Image capture units 105 have an image sensor such as a CCD or CMOS sensor. The image capture units 105 obtain analog image signals by photoelectrically converting optical images formed on image sensor surfaces via image capture optical systems 104. The image capture units 105 also apply analog-to-digital conversion processing to the analog image signals and output digital image signals (hereinafter simply referred to as images). The digital camcorder 100 according to the present embodiment is what is called a twin-lens image capture apparatus including two image capture optical systems 104 and two image capture units 105, so as to capture left-eye and right-eye images used in binocular stereopsis. Two image capture optical systems 104 are disposed with a base-line length, and form optical images having horizontal parallax on corresponding image capture units 105.

It should be noted that, in the description below, the letter “L” is appended to the image capture optical systems 104 and image capture units 105 when describing configurations related to image capture for the left eye, and the letter “R” is appended to the image capture optical systems 104 and image capture units 105 when describing configurations related to image capture for the right eye. When the image capture optical systems 104 and image capture units 105 are noted without the letters “L” and “R” appended thereto, it means that the description applies to both or any one of configurations for the left eye and for the right eye.

An image processing unit 106 applies various types of image processing to input images, including image processing for displaying the input images on a later-described display unit 108. Images that are input to the image processing unit 106 may be images output from the image capture units 105, and images stored in a later-described storage medium 111.

The display unit 108 is a display apparatus such as, for example, an LCD included in the digital camcorder 100 of the present embodiment. The display unit 108 of the present embodiment displays a left-eye image and a right-eye image alternately using a time-division scheme. An observer can stereoscopically perceive the content displayed on the display unit 108 with the use of liquid crystal shutter glasses that switch between opened and closed states in synchronization with timings for switching between left-eye and right-eye images to be displayed. More specifically, when the display unit 108 displays a left-eye image, the liquid crystal shutter glasses place a liquid crystal shutter corresponding to the left eye in a transmissive state, and a liquid crystal shutter corresponding to the right eye in a non-transmissive state. On the other hand, when the display unit 108 displays a right-eye image, the liquid crystal shutter glasses place the liquid crystal shutter corresponding to the right eye in a transmissive state, and the liquid crystal shutter corresponding to the left eye in a non-transmissive state. That is to say, when the display unit 108 displays an image that is intended to be viewed by one of the eyes, the liquid crystal shutter glasses allow light of the image to be incident on that eye. When the display unit 108 displays an image that is not intended to be viewed by one of the eyes, the liquid crystal shutter glasses block light of the image from being incident on that eye. In this way, binocular stereopsis is realized whereby different eyes view different images.

It should be noted that a display control unit 107 executes control related to display on the display unit 108. More specifically, the display control unit 107 controls the display unit 108 to display input left-eye and right-eye images for binocular stereopsis at appropriate timings.

A synchronization signal generation unit 109 generates synchronization signals for instructing the liquid crystal shutter glasses worn by the observer regarding timings for switching between left-eye and right-eye images on the display unit 108. The synchronization signals may be represented by, for example, emission of infrared light. In this case, the synchronization signals may imply display of a left-eye image on the display unit 108 via emission of the infrared light, and display of a right-eye image on the display unit 108 via non-emission of the infrared light. Upon receiving the synchronization signals, the liquid crystal shutter glasses perform control such that one of the liquid crystal shutters is placed in a transmissive state.

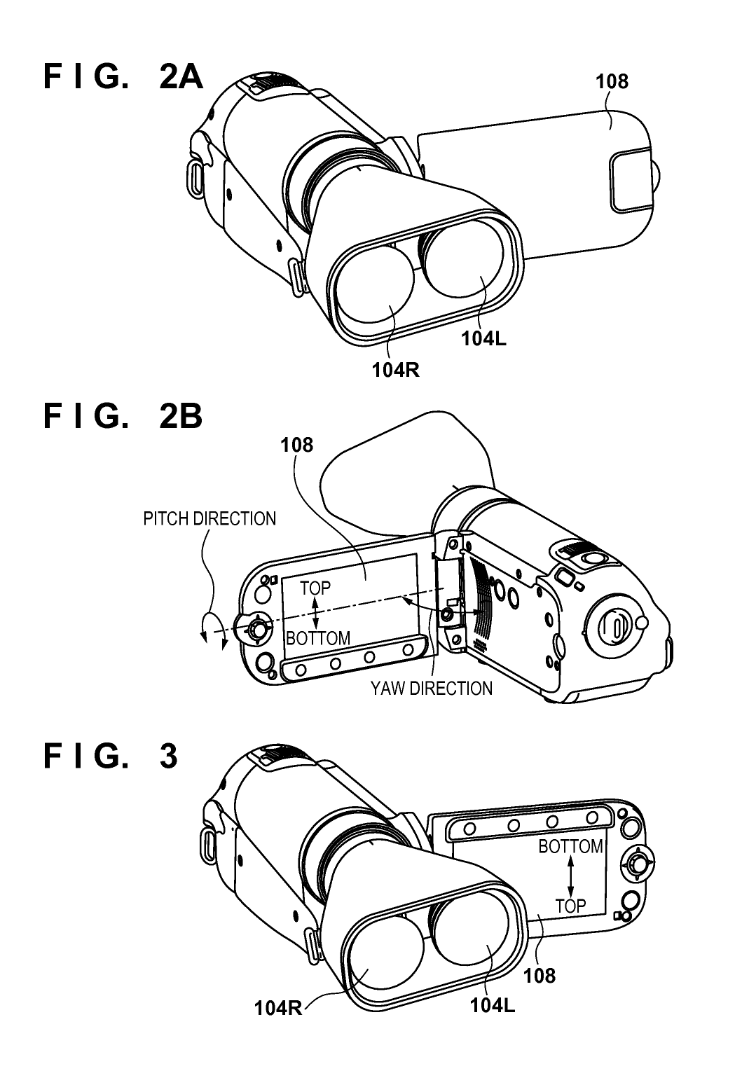

A state detection unit 110 detects a state of placement of the display unit 108 included in the digital camcorder 100 of the present embodiment. A description is now given of possible states of placement of the display unit 108 according to the present embodiment with reference to the drawings. FIGS. 2A and 2B illustrate a state of placement of the display unit 108 during, for example, normal image capture. It should be noted that normal image capture is performed in a state where a subject and a camera operator face each other and a display surface of the display unit 108 faces the camera operator. During normal image capture, the display surface faces the camera operator when the display unit 108 has been opened, that is to say, rotated away from a side of the digital camcorder 100 by 90 degrees in the yaw direction, as shown in FIG. 2B.

The display unit 108 of the present embodiment further has a mechanism for rotation in the pitch direction as shown in the figures. When the display unit 108 has been rotated by 180 degrees in the pitch direction, the display surface faces the subject as shown in FIG. 3. FIG. 3 illustrates a state of placement of the display unit 108 during, for example, what is called self image capture. It should be noted that during self image capture, the subject is the camera operator. As a result of the rotation in the pitch direction, the front and back of the display unit 108 are inverted. When the display unit 108 is rotated in the pitch direction so that the front and back thereof are inverted, the top and bottom of the display apparatus are also inverted.

The state detection unit 110 is, for example, a rotation detection switch provided in the rotating mechanism. In the present embodiment, the state detection unit 110 detects whether or not the front and back of the display unit 108 are inverted, and informs the control unit 101 of the result of detection.

The storage medium 111 is a storage apparatus such as a memory card and an HDD that is connected to the digital camcorder 100 in an attachable and detachable manner. Still images and moving images that are obtained through image capture performed by the image capture units 105 are stored in the storage medium 111.

<<Failure in Binocular Stereopsis Caused by Left-Right Inversion Processing for Images>>

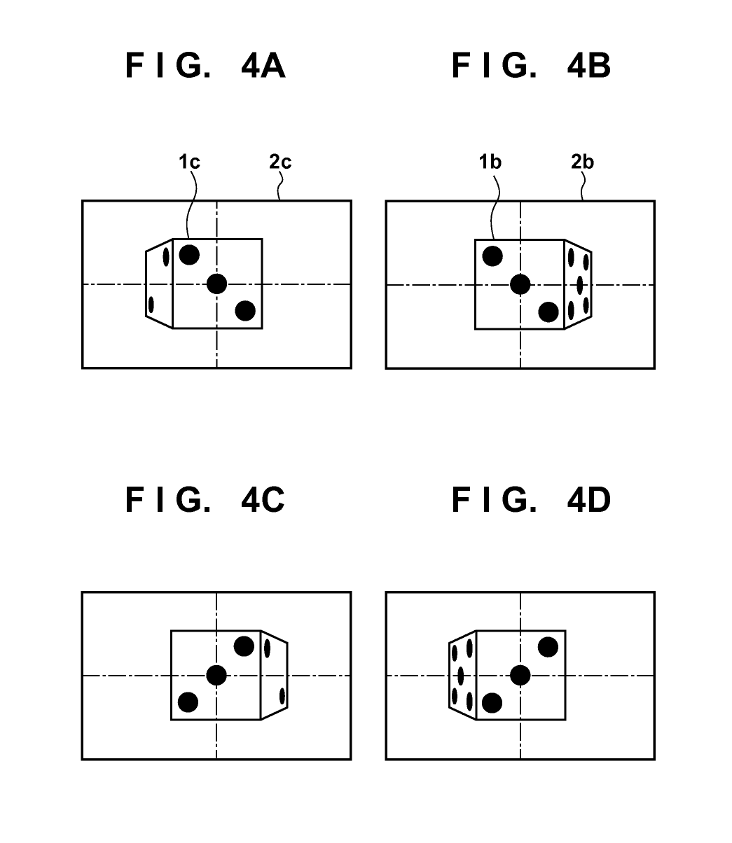

The following describes in detail failure in binocular stereopsis that occurs when the digital camcorder 100 of the present embodiment performs image capture while the display surface of the display unit 108 is facing the subject, with reference to FIGS. 4A to 4D.

When the display surface of the display unit 108 is facing the subject during image capture, by displaying images with left and right inverted as described in Patent Document 1 mentioned above, a positional relationship with a target of image capture (the subject) from the viewpoint of the subject can easily be grasped. A case is considered in which, as in the digital camcorder 100 according to the present embodiment, the display unit 108 is a display apparatus that enables binocular stereopsis and performs through-the-lens display of images captured by the image capture units 105.

Assume that in a normal state of placement where the display surface of the display unit 108 faces a direction opposite from the subject, a left-eye image and a right-eye image that are alternately displayed on the display unit 108 are as shown in FIGS. 4A and 4B. FIGS. 4A and 4B show the left-eye image and the right-eye image, respectively. A dice that is the subject looks different between the two images.

When the front and back of the display unit 108 are inverted so that the display surface of the display unit 108 faces the subject, left and right inversion image processing is applied to the left-eye and right-eye images so as to display them on the display unit 108, and the resultant left-eye and right-eye images are as shown in FIGS. 4C and 4D. However, when each of these inverted images is displayed so as to be viewed by the same eye that viewed the original image preceding the left-right inversion, binocular stereopsis cannot be realized, or the inverted images are displayed with a different stereoscopic effect.

This is attributed to the following factor: in binocular stereopsis, while the left-eye and right-eye directions intersect (convergence) so as to perceive the stereoscopic effect, the state of the target cannot be perceived correctly because the “appearance” of the target in the eye directions defined by convergence has changed due to the left-right inversion. For example, consider the case in which the appearance of the target to the left eye of the observer has changed from FIG. 4A to FIG. 4C, with the eye direction of the left eye of the observer unchanged. In this case, as an image (the number two face of the dice) is visible in a direction that is intended to be blocked and not visible, the left eye of the observer perceives the dice as if the dice had rolled more leftward on the screen than in reality.

Likewise, as the appearance of the target to the right eye of the observer has changed from FIG. 4B to FIG. 4D, the right eye of the observer perceives the dice as if the dice had rolled more rightward on the screen than in reality. In binocular stereopsis using these two images, they cannot be perceived as correct stereoscopic images.

In order to prevent failure in binocular stereopsis caused by the left-right inversion, the digital camcorder 100 of the present embodiment reverses the timings at which these images are displayed when the display unit 108 displays left-eye and right-eye images after left-right inversion processing has been applied thereto. That is, while the left-eye shutter of the liquid crystal shutter glasses is in a transmissive state, the display unit 108 displays a right-eye image with left and right inverted, and while the right-eye shutter of the liquid crystal shutter glasses is in a transmissive state, the display unit 108 displays a left-eye image with left and right inverted.

That is to say, when the display unit 108 displays images with left and right not inverted in such a manner that they can be viewed in binocular stereopsis, at timings for displaying images to be viewed by the left and right eyes of the observer, the display control unit 107 outputs images captured by the corresponding image capture units 105, as shown in the following table.

| | DISPLAY TIMING | | | | | |
|---|---|---|---|---|---|---|
| | FOR | FOR | FOR | FOR | FOR | FOR |
| | LEFT | RIGHT | LEFT | RIGHT | LEFT | RIGHT |
| | EYE | EYE | EYE | EYE | EYE | EYE |
| LEFT- | OUT- | | OUTPUT | | OUTPUT | |
| EYE | PUT | | | | | |
| IMAGE | | | | | | |
| RIGHT- | | OUT- | | OUTPUT | | OUTPUT |
| EYE | | PUT | | | | |
| IMAGE | | | | | | |

On the other hand, when the display unit 108 displays images with left and right inverted (mirror images) in such a manner that they can be viewed in binocular stereopsis, at timings for displaying images to be viewed by the left and right eyes of the observer, the display control unit 107 outputs images captured by the image capture units 105 corresponding to the opposite eyes, as shown in the following table.

| | DISPLAY TIMING | | | | | |
|---|---|---|---|---|---|---|
| | FOR | FOR | FOR | FOR | FOR | FOR |
| | LEFT | RIGHT | LEFT | RIGHT | LEFT | RIGHT |
| | EYE | EYE | EYE | EYE | EYE | EYE |
| LEFT-EYE | | OUT- | | OUTPUT | | OUTPUT |
| IMAGE | | PUT | | | | |
| (MIRROR) | | | | | | |
| RIGHT-EYE | OUT- | | OUT- | | OUTPUT | |
| IMAGE | PUT | | PUT | | | |
| (MIRROR) | | | | | | |

In this way, even when left and right are inverted, the observer can perceive the stereoscopic effect of binocular stereopsis without failure.

<<Display Control Processing>>

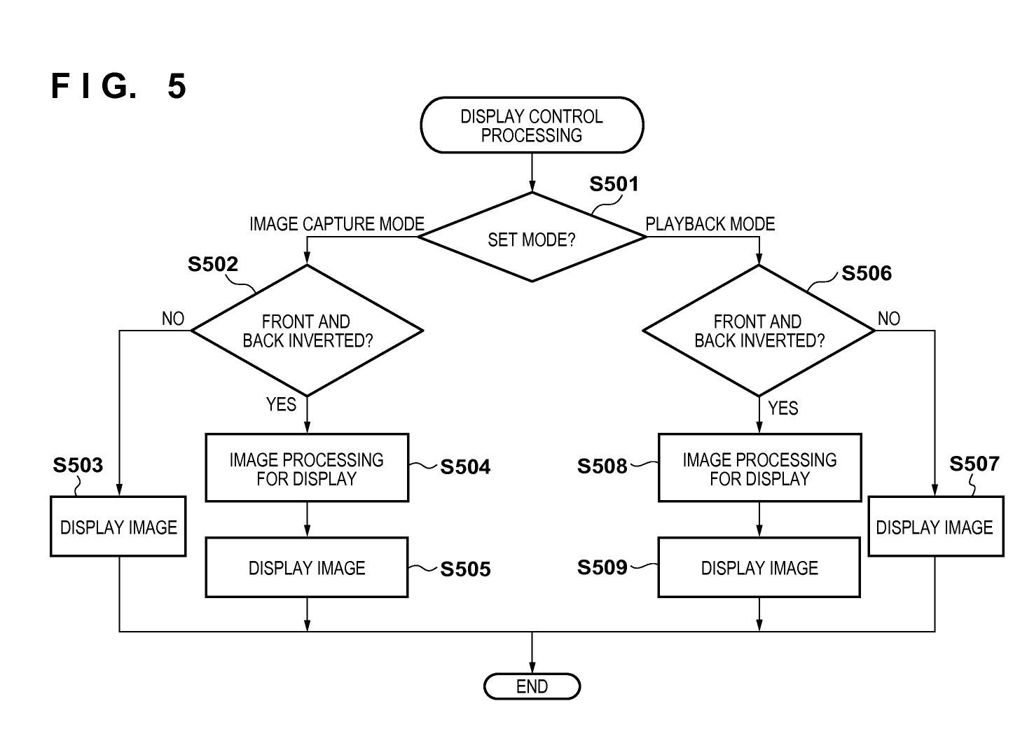

The following describes the specifics of display control processing executed by the digital camcorder 100 of the present embodiment with the above configuration with reference to a flowchart of FIG. 5. The processing corresponding to this flowchart can be realized by the control unit 101 reading a corresponding processing program stored in the ROM 102 for example, deploying the processing program to the RAM 103, and executing the deployed processing program. The following description is given under the assumption that this display control processing is started, for example, upon activation of the digital camcorder 100 and executed repeatedly.

In S501, the control unit 101 determines whether a mode currently set in the digital camcorder 100 is an image capture mode or a playback mode. The control unit 101 proceeds to the process of S502 when it determines that the image capture mode is currently set, and to the process of S506 when it determines that the playback mode is currently set.

In step S502, the control unit 101 determines whether the state of the display unit 108 detected by the state detection unit 110 is a normal state of placement, or a state of placement where the front and back of the display unit 108 are determined to be inverted. In other words, the control unit 101 determines whether the display unit 108 is in a state of placement where it is not necessary to apply the left-right inversion processing to images to be displayed on the display unit 108, or in a state of placement where it is necessary to apply the left-right inversion processing to images to be displayed on the display unit 108. It should be noted that the display unit 108 need not be rotated by 180 degrees in the pitch direction as described above to be in the state of placement where the front and back thereof are determined to be inverted. The display unit 108 is considered to be in this state of placement when a degree by which it has been rotated falls within a range that has been predetermined as a trigger to switch between display methods. The control unit 101 proceeds to the process of S503 when it determines that the display unit 108 is in the normal state of placement, and to the process of S504 when it determines that the display unit 108 is in a state of placement where the front and back thereof are inverted.

In S503, the control unit 101 transfers left-eye and right-eye images output from the image capture units 105 to the display control unit 107, and causes the display control unit 107 to output the left-eye and right-eye images at predetermined timings so that the left-eye and right-eye images are displayed on the display unit 108. More specifically, at a timing for displaying an image to be viewed by the left eye of the observer on the display unit 108 (while the left-eye liquid crystal shutter is transmissive and the right-eye liquid crystal shutter is blocking light), the display control unit 107 outputs the left-eye image output from the image capture unit 105L to the display unit 108 and causes the display unit 108 to display the left-eye image. Likewise, at a timing for displaying an image to be viewed by the right eye of the observer (while the right-eye liquid crystal shutter is transmissive and the left-eye liquid crystal shutter is blocking light), the display control unit 107 outputs the right-eye image output from the image capture unit 105R and causes the right-eye image to be displayed.

On the other hand, when the control unit 101 determines in S502 that the display unit 108 is in a state of placement where the front and back thereof are inverted, the control unit 101 causes the image processing unit 106 to apply image processing for display to the left-eye and right-eye images output from the image capture units 105 in S504. In the digital camcorder 100 of the present embodiment, the front and back of the display unit 108 are inverted through rotation in the pitch direction, and therefore it is necessary to apply both the left-right inversion processing and top-bottom inversion processing to images to be displayed. The image processing unit 106 applies the top-bottom inversion processing and left-right inversion processing to each of the left-eye and right-eye images.

In S505, the control unit 101 transfers the left-eye and right-eye images to which the image processing unit 106 has applied the image processing for display to the display control unit 107, and causes the display control unit 107 to output the left-eye and right-eye images at predetermined timings so that the left-eye and right-eye images are displayed on the display unit 108. More specifically, at a timing for displaying an image to be viewed by the left eye of the observer on the display unit 108, the display control unit 107 outputs to the display unit 108 the right-eye image which has been output from the image capture unit 105R and to which the image processing unit 106 has applied the left-right inversion processing, and causes the display unit 108 to display the right-eye image. Likewise, at a timing for displaying an image to be viewed by the right eye of the observer, the display control unit 107 outputs to the display unit 108 the left-eye image which has been output from the image capture unit 105L and to which the image processing unit 106 has applied the left-right inversion processing, and causes the display unit 108 to display the left-eye image. That is to say, in the state of placement where the front and back of the display unit 108 are inverted, the output timings of the left-eye and right-eye images to be displayed on the display unit 108 are obtained by reversing the output timings of these images in the normal state of placement.

Meanwhile, when the control unit 101 determines in S501 that the playback mode is currently set in the digital camcorder 100, the control unit 101 determines in S506 whether the state of the display unit 108 is the normal state of placement, or the state of placement where the front and back of the display unit 108 are inverted. The control unit 101 proceeds to the process of S507 when it determines that the display unit 108 is in the normal state of placement, and to the process of S508 when it determines that the display unit 108 is in the state of placement where the front and back thereof are inverted.

In S507, the control unit 101 transfers left-eye and right-eye images that have been read from the storage medium 111 and belong to an image file or a moving image file to be played back to the display control unit 107, and causes the display control unit 107 to output the left-eye and right-eye images at predetermined timings so that the left-eye and right-eye images are displayed on the display unit 108. More specifically, at a timing for displaying an image to be viewed by the left eye of the observer on the display unit 108, the display control unit 107 outputs a left-eye image that belongs to the image file or the moving image file to be played back to the display unit 108, and causes the display unit 108 to display the left-eye image. Likewise, at a timing for displaying an image to be viewed by the right eye of the observer, the display control unit 107 outputs a right-eye image that belongs to the image file or the moving image file to be played back to the display unit 108, and causes the display unit 108 to display the right-eye image.

On the other hand, when the control unit 101 determines in S506 that the display unit 108 is in the state of placement where the front and back thereof are inverted, the control unit 101 reads the image file or the moving image file to be played back from the storage medium 111 in S508. Then, the control unit 101 transfers left-eye and right-eye images that belong to the image file or the moving image file to be played back to the image processing unit 106, and causes the image processing unit 106 to apply image processing for display to the left-eye and right-eye images. The image processing unit 106 applies the top-bottom inversion processing to each of the left-eye and right-eye images to be played back. It is not necessary to display the stored contents for binocular stereopsis with the inversion of left and right. Therefore, in the digital camcorder 100 of the present embodiment, when the display unit 108 is in the state of placement where the front and back thereof are inverted during the playback mode, the display unit 108 displays images to which only the top-bottom inversion processing has been applied.

In S509, the control unit 101 transfers the left-eye and right-eye images to which the image processing unit 106 has applied the image processing for display to the display control unit 107, and causes the display control unit 107 to output the left-eye and right-eye images at predetermined timings so that the left-eye and right-eye images are displayed on the display unit 108. More specifically, at a timing for displaying an image to be viewed by the left eye of the observer on the display unit 108, the display control unit 107 outputs to the display unit 108 a left-eye image to which the top-bottom inversion processing has been applied and which belongs to the image file or the moving image file to be played back, and causes the display unit 108 to display the left-eye image. Likewise, at a timing for displaying an image to be viewed by the right eye of the observer on the display unit 108, the display control unit 107 outputs to the display unit 108 a right-eye image to which the top-bottom inversion processing has been applied and which belongs to the image file or the moving image file to be played back, and causes the display unit 108 to display the right-eye image.

As described above, the display control apparatus according to the present embodiment allows the observer to perceive the correct stereoscopic effect when displaying images for binocular stereopsis with left and right inverted. More specifically, when image processing for performing left-right inversion of images has been applied to obtained left-eye and right-eye images for binocular stereopsis, the display control apparatus outputs the left-eye image with left and right inverted so that it is displayed on the display apparatus for the right eye. Likewise, the display control apparatus outputs the right-eye image with left and right inverted so that it is displayed on the display apparatus for the left eye. The display apparatus displays these left-eye and right-eye images in such a manner that they can be viewed in binocular stereopsis.

Variation

The above embodiment has described an example in which, when displaying left-eye and right-eye images with left and right inverted in such a manner that they can be viewed in binocular stereopsis using a liquid crystal shutter method, the timings of display on the display unit 108 are reversed so as to realize binocular stereopsis in a normal manner. However, when the liquid crystal shutter method is used, the present invention is not limited in this way, and may be realized by placing the liquid crystal shutter glasses in a transmissive state at different timings. The present variation describes a method for allowing the observer to perceive the correct stereoscopic effect by, when displaying left-eye and right-eye images with left and right inverted in such a manner that they can be viewed in binocular stereopsis, causing the liquid crystal shutter glasses to be transmissive and block light at different timings.

When the display unit 108 displays images in which left and right are not inverted in such a manner that they can be viewed in binocular stereopsis, at a timing for displaying each of left-eye and right-eye images captured by the image capture units 105, the liquid crystal shutter for the corresponding eye is placed in a transmissive state, and the liquid crystal shutter for the other non-corresponding eye blocks light, as shown in the following table.

| | DISPLAY TIMING | | | | | |
|---|---|---|---|---|---|---|
| | FOR | FOR | FOR | FOR | FOR | FOR |
| | LEFT | RIGHT | LEFT | RIGHT | LEFT | RIGHT |
| | EYE | EYE | EYE | EYE | EYE | EYE |
| LEFT- | TRANSMISSIVE | BLOCK | TRANSMISSIVE | BLOCK | TRANSMISSIVE | BLOCK |
| EYE | | | | | | |
| SHUTTER | | | | | | |
| RIGHT- | BLOCK | TRANSMISSIVE | BLOCK | TRANSMISSIVE | BLOCK | TRANSMISSIVE |
| EYE | | | | | | |
| SHUTTER | | | | | | |

On the other hand, when the display unit 108 displays images in which left and right are inverted (mirror images) in such a manner that they can be viewed in binocular stereopsis, at a timing for displaying each left-eye and right-eye image captured by the image capture units 105, the liquid crystal shutter for the corresponding eye blocks light, and the liquid crystal shutter for the other non-corresponding eye is placed in a transmissive state, as shown in the following table.

| | DISPLAY TIMING | | | | | |
|---|---|---|---|---|---|---|
| | FOR | FOR | FOR | FOR | FOR | FOR |
| | LEFT | RIGHT | LEFT | RIGHT | LEFT | RIGHT |
| | EYE | EYE | EYE | EYE | EYE | EYE |
| LEFT- | BLOCK | TRANSMISSIVE | BLOCK | TRANSMISSIVE | BLOCK | TRANSMISSIVE |
| EYE | | | | | | |
| SHUTTER | | | | | | |
| RIGHT- | TRANSMISSIVE | BLOCK | TRANSMISSIVE | BLOCK | TRANSMISSIVE | BLOCK |
| EYE | | | | | | |
| SHUTTER | | | | | | |

The synchronization signal generation unit 109 controls the states of the shutters of the liquid crystal shutter glasses. That is to say, when the display unit 108 is in a state of placement where the front and back thereof are inverted during the image capture mode, the control unit 101 reverses the timing at which the synchronization signal generation unit 109 generates a synchronization signal in the normal state of placement. For example, assume that in the normal state of placement, the synchronization signal generation unit 109 transmits a signal at a timing for placing the left-eye liquid crystal shutter in a transmissive state. In this case, in the state of placement where the front and back of the display unit 108 are inverted, the synchronization signal generation unit 109 is controlled to transmit a signal at a timing for placing the right-eye liquid crystal shutter in a transmissive state.

In this way, even when left and right are inverted, the observer can perceive the stereoscopic effect of binocular stereopsis without failure.

### Embodiment 2

In the above Embodiment 1 and Variation, the present invention is carried out using the liquid crystal shutter method. On the other hand, the present embodiment describes the application of the present invention using methods other than the liquid crystal shutter method. Note that these other methods require the observer to wear a device (glasses provided with filters) that enables binocular stereopsis.

Examples of methods for physically blocking light from being incident on the left and right eyes without using the liquid crystal shutter glasses include a polarization method that uses linear and circular polarizing filters, and a wavelength separation method such as anaglyph and INFITEC. These methods do not require synchronization with a device worn by the observer, and hence do not require the synchronization signal generation unit 109. In both of these methods, filters that partially allow light to travel therethrough are arranged for the eyes of the observer. When these methods are used, it is necessary for images that are displayed on the display apparatus to be made compatible with the filters. Examples of control methods for making images compatible with the filters include a control method for displaying the images while switching between filters that serve as physical hardware on the display apparatus as with the polarization method, and a control method for switching between filter processes to be applied to image processing.

By using such control methods, images to be viewed by the left and right eyes of the observer can be controlled, thus enabling display control whereby captured images to which the left-right inversion processing has been applied are each viewed through a filter for the opposite eye. In this way, even when left and right are inverted, the observer can perceive the stereoscopic effect of binocular stereopsis without failure.

### Embodiment 3

The above Embodiments 1 and 2 and Variation have described methods for displaying different left-eye and right-eye images on the screen using a time-division scheme. However, the present invention is not limited to being carried out in this way, and is also applicable to a display apparatus that enables autostereoscopy through simultaneous display of left-eye and right-eye images. The present embodiment describes an example in which the present invention is applied to a display apparatus that enables autostereoscopy with the use of a parallax barrier method, a lenticular method, or the like.

A display apparatus that enables autostereoscopy causes light of a displayed image to travel in certain directions so that, when the displayed image is seen from the positions of the left and right eyes of the observer, the left and right eyes of the observer view different images. That is to say, the display apparatus displays an image generated by compositing left-eye and right-eye images in such a manner that different display areas include different images to be viewed.

When the display unit 108 is a display apparatus that enables autostereoscopy, display control executed through the application of the present invention varies depending on the state of placement of the display unit 108 as follows. For example, in the case where the front and back of the display unit 108 are inverted through rotation in the pitch direction as described above, the direction in which light of a left-eye image travels in the state of placement where the front and back of the display unit 108 are inverted is the same as the direction in which light of a right-eye image travels in the normal state of placement. In other words, when the front and back of the display unit 108 are inverted through rotation in the pitch direction, pixels that display a captured right-eye image are viewed by the left eye of the observer. That is to say, in the case where the front and back of the display unit 108 is inverted through rotation in the pitch direction, a certain display area is viewed by one eye of the observer in the normal state of placement and by the other eye of the observer in the state of placement where the front and back of the display unit 108 are inverted, and therefore it is not necessary to execute control to reverse display areas in which images are displayed with left and right inverted.

On the other hand, for example, in the case where the display unit 108 is attached to the digital camcorder 100 with a mechanism to invert the front and back thereof through rotation in the yaw direction, the above reversing does not occur. That is to say, in the case where the front and back of the display unit 108 is inverted through rotation in the yaw direction, a certain display area is viewed by the same eye of the observer both in the normal state of placement and in the state of placement where the front and back of the display unit 108 are inverted, and therefore it is necessary to execute processing for reversing areas where images are arranged when generating images to be displayed.

In other words, when the present invention is applied to a display apparatus that enables autostereoscopy, in a state where the display apparatus is placed, pixels to be viewed by the left eye of the observer display a captured right-eye image with left and right inverted, and pixels to be viewed by the right eye of the observer display a captured left-eye image with left and right inverted. In this way, even when left and right are inverted, the observer can perceive the stereoscopic effect of binocular stereopsis without failure as in other embodiments.

It should be noted that a single item of hardware may control the display control apparatus, or the entire apparatus may be controlled by a plurality of items of hardware sharing processing.

While the present invention has been described in detail above based on suitable embodiments thereof, the present invention is by no means limited to these specific embodiments and includes various embodiments without departing from the concept of the present invention. Furthermore, the above embodiments are merely illustrative embodiments of the present invention, and may be combined where appropriate.

While the above embodiments have described an example in which the present invention is applied to a digital camcorder, the present invention is not limited to this example. The present invention is applicable to any display control apparatus capable of outputting left-eye and right-eye images for binocular stereopsis. More specifically, the present invention is applicable to a personal computer, a PDA, a mobile telephone terminal, a mobile image viewer, a printer apparatus provided with a display, a digital photo frame, a music player, a game console, an electronic book reader, and the like.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-200878, filed Sep. 12, 2012, which is hereby incorporated by reference herein in its entirety.

What is claimed is:

1. A display control apparatus comprising:
an obtaining unit configured to obtain a left-eye image and a right-eye image for binocular stereopsis;
an image processing unit configured to apply image processing for display to the left-eye image and the right-eye image obtained by the obtaining unit; and
a display output unit configured to output the left-eye image and the right-eye image to which the image processing unit has applied the image processing for display to a display apparatus capable of display in binocular stereopsis,
wherein the display output unit includes:
a left-eye display output unit configured to output an image to be displayed on the display apparatus for a left eye; and
a right-eye display output unit configured to output an image to be displayed on the display apparatus for a right eye, and
in a case where the image processing unit applies image processing for performing left-right inversion of images, the display output unit causes the right-eye display output unit to output the left-eye image with left and right inverted, and causes the left-eye display output unit to output the right-eye image with left and right inverted.

2. The display control apparatus according to claim 1,
wherein the left-eye display output unit and the right-eye display output unit output images alternately.

3. The display control apparatus according to claim 2,
wherein the display apparatus is observed by an observer using a blocking device that blocks light of displayed content incident on a left eye and a right eye of the observer alternately, in synchronization with timings for switching between an output from the left-eye display output unit and an output from the right-eye display output unit,
the left-eye display output unit outputs an image to be displayed on the display apparatus while the blocking device is blocking light incident on the right eye of the observer and is not blocking light incident on the left eye of the observer, and
the right-eye display output unit outputs an image to be displayed on the display apparatus while the blocking device is blocking light incident on the left eye of the observer and is not blocking light incident on the right eye of the observer.

4. The display control apparatus according to claim 3, further comprising
an instruction unit configured to instruct the blocking device regarding timings at which the blocking device blocks light incident on the left eye and the right eye of the observer,
wherein in a case where the image processing unit applies the image processing for performing left-right inversion of images, the instruction unit reverses a timing for blocking light incident on the left eye of the observer and a timing for blocking light incident on the right eye of the observer for a case where said image processing is not applied, and instructs the blocking device regarding the reversed timings.

5. The display control apparatus according to claim 2,
wherein the display apparatus displays images while alternately applying, to the images, filters corresponding to respective filters that are applied to a left eye and a right eye of the observer, in synchronization with timings for switching between an output from the left-eye display output unit and an output from the right-eye display output unit,
the left-eye display output unit outputs an image to be displayed on the display apparatus when a filter corresponding to a filter that is applied to the left eye of the observer is applied by the display apparatus, and
the right-eye display output unit outputs an image to be displayed on the display apparatus when a filter corresponding to a filter that is applied to the right eye of the observer is applied by the display apparatus.

6. The display control apparatus according to claim 1, further comprising
a detection unit configured to detect a placement of the display apparatus in which a front and a back of the display apparatus are inverted,
wherein the image processing unit applies the image processing for performing left-right inversion of images when the detection unit has detected the placement of the display apparatus in which the front and the back of the display apparatus are inverted.

7. The display control apparatus according to claim 1,
wherein the display apparatus enables autostereoscopy by simultaneously displaying an image output from the left-eye display output unit and an image output from the right-eye display output unit,
the display control apparatus further comprises a detection unit configured to detect a state of placement of the display apparatus,
in the state of placement of the display apparatus detected by the detection unit, the left-eye display output unit outputs an image to be displayed on the display apparatus for the left eye of the observer, and
in the state of placement of the display apparatus detected by the detection unit, the right-eye display output unit outputs an image to be displayed on the display apparatus for the right eye of the observer.

8. The display control apparatus according to claim 7,
wherein the image processing unit applies the image processing for performing left-right inversion of images when it is determined that the state of placement of the display apparatus detected by the detection unit is a state where a front and a back of the display apparatus are inverted.

9. An image capture apparatus comprising:
an image capture unit configured to capture a left-eye image and a right-eye image for binocular stereopsis;
a setting unit configured to set one of a plurality of modes of the image capture apparatus, the modes including at least an image capture mode for capturing an image of a subject using the image capture unit, and a playback mode for playing back an image stored in a storage unit; and
the display control apparatus according to claim 1,
wherein the image processing unit of the display control apparatus applies the image processing for performing left-right inversion of images when the image capture mode is set by the setting unit.

10. A control method for a display control apparatus, the control method comprising:
an obtaining step in which an obtaining unit of the display control apparatus obtains a left-eye image and a right-eye image for binocular stereopsis;
an image processing step in which an image processing unit of the display control apparatus applies image processing for display to the left-eye image and the right-eye image obtained in the obtaining step; and
a display output step in which a display output unit of the display control apparatus outputs the left-eye image and the right-eye image to which the image processing for display has been applied in the image processing step to a display apparatus that enables display in binocular stereopsis,
wherein the display output unit includes:
a left-eye display output unit configured to output an image to be displayed on the display apparatus for a left eye; and
a right-eye display output unit configured to output an image to be displayed on the display apparatus for a right eye, and
in a case where image processing for performing left-right inversion of images is applied in the image processing step, the display output unit causes the right-eye display output unit to output the left-eye image with left and right inverted and causes the left-eye display output unit to output the right-eye image with left and right inverted in the display output step.

11. A computer-readable non-transitory storage medium having stored therein a program for causing a computer to function as the units of the display control apparatus according to claim 1.
